(19) United States
(12) Patent Application Publication
(10) Pub. No.: US 2002/0198944 A1
(43) Pub. Date: Dec. 26, 2002

(54) Method for distributing large files to multiple recipients

(76) Inventor: Pamela M. Moss, Scarsdale, NY (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 09/885,671

(22) Filed: Jun. 20, 2001

(51) Int. Cl. G06F 15/16

(52) U.S. Cl. 709/206; 709/231

(57) ABSTRACT

Systems and methods are provided for distributing large files, such as media files (e.g., audio, video, and multimedia files), over a server or other file exchange platform. In some embodiments of the method, an electronic message having a file attached thereto is provided which designates a plurality of recipients. A single copy of the file is uploaded to a first server. Then, for each designated recipient, the file is transmitted from the first server to the designated recipient. In other embodiments, the attached file is resident on a remote server. The message is then sent to each recipient along with an identifier that uniquely identifies the file. For each recipient, when the message is opened, the file is sent from the first server to the recipient.

### FIELD OF THE INVENTION

This invention relates generally to methods for distributing files to multiple recipients and, in particular, to a method for distributing media files to multiple recipients.

### BACKGROUND OF THE INVENTION

Numerous systems are known for distributing files to multiple recipients over a server associated with a user. Common examples include electronic mail systems such as Lotus Notes®, which allow users to attach one or more files to an electronic message, and then specify one or more recipients to whom the electronic message will be sent.

While such systems work quite well for the distribution of small files over a server, the distribution of larger attachments, such as media files, is more problematic, because it typically results in multiple instances of the same large file being stored on the server. For example, an audio file of approximately 5 minutes in duration which is encoded at a bit rate of 64 kbps will typically be about 2 megabytes in size. Audio files encoded at higher, more commonly used bit rates would be even larger. Thus, the same 5-minute audio file encoded at 96 kbps and 128 kbps would have a file size of about 3 and 5 megabytes in size, respectively. The existence of multiple instances of files of this size on a server may adversely affect server performance and speed, and may even result in disruption of the server as memory capacities or bandwidth limitations are exceeded. Accordingly, traditional methods of distributing files electronically to multiple users are not well suited to the distribution of media files and other large file types.

Some systems are known to the art which do not rely on the direct incorporation of a file into an electronic message. For example, later versions of electronic mail systems such as Lotus Notes® or Outlook Express® allow a user to incorporate a hyperlink into the body of a textual message. The hyperlink contains the address of a specific web page. The file or files corresponding to that web page may reside on a server distinct from that associated with the sender or recipient of the message. The recipient of the message may then access the web page pointed to by the hyperlink simply by clicking on the link. When the user clicks on the hyperlink, the user's Internet browser will attempt to access the site pointed to by the link and, in doing so, may download into its temporary cache picture or data files that are associated with the site. As noted previously, these picture or data files may reside on a server distinct from that associated with the recipient of the message. Therefore, when the recipient clicks on the hyperlink, this has the effect of downloading the picture or data files from the distant server to the user's server, system, and/or drive. However, while this system is advantageous in that it avoids the need to incorporate the picture or data files directly into the electronic message itself, thus preserving memory space and/or bandwidth, it is disadvantageous in that it requires the sender to know the address of the web page to begin with. Moreover, systems of this type also require the user to take affirmative action in order to preserve memory space and/or bandwidth on a server, since the hyperlink is only provided if the user creates one. Hence, systems of this type are not proactive.

There is thus a need in the art for a system and method for distributing large files, such as music files, via electronic mail to multiple designated recipients over a server associated with a user such that creation of multiple copies of the file on the server are avoided. There is also a need in the art for a method and system for distributing large files over a server which reduces or eliminates the need for copying large files to the server. These and other needs are met by the present invention, as hereinafter described.

### SUMMARY OF THE INVENTION

The present invention relates to systems and methods for distributing large files, such as media files (e.g., audio, video, and multimedia files), over a server or other file exchange platform.

In accordance with one aspect of the present invention, an electronic message is generated by an author which designates a file as an attachment and which designates a plurality of recipients. When the author indicates that the message is to be sent, a software package operating over the author's server accesses the message and ascertains the identification of the attached file. The software is equipped with a library of frequently transmitted files which are present on one or more remote servers. The software then queries the library to determine whether the attached file is in the library. If so, the software instructs the remote server to send a copy of the file directly to the e-mail address of each of the designated recipients. If not, the software sends the message and the attached file to the designated recipients in a conventional manner. In a variation of this embodiment, some or all of the files in the library may be resident on the author's server, in which case the software may instruct the author's server to send a copy of the file directly to the e-mail address of each of the designated recipients.

In accordance with another aspect of the present invention, an electronic message is generated by an author which designates a file as an attachment and which designates a plurality of recipients. When the author indicates that the message is to be sent, a software package operating over the author's server accesses the message and ascertains the identification of the attached file. The software then queries one or more remote servers with the identification of the attached file to determine if a copy of the file resides on one of the remote servers. If a duplicate of the file is found to reside on one of the remote servers, the software instructs the remote server to send a copy of the file directly to the e-mail address of each of the designated recipients. If not, the software sends the message and the attached file to the designated recipients in a conventional manner.

In accordance with yet another aspect of the present invention, an electronic message is generated by an author which designates a file as an attachment and which designates a plurality of recipients. When the author indicates that the message is to be sent, a software package operating over the author's server accesses the message and ascertains the identification of the attached file. The software then queries one or more remote servers with the identification of the attached file to determine if a copy of the file resides on one of the remote servers. If a duplicate of the file is found to reside on one of the remote servers, the software then creates a hyperlink to the appropriate address on the remote server and incorporates the hyperlink into the message. The software then sends the message incorporating the hyperlink to the designated recipients. If no duplicate of the file is found on a remote server, the software sends the message and the attached file to the designated recipients in a conventional manner.

In accordance with still another aspect of the present invention, an electronic message is generated by a user or author which designates a file as an attachment and which designates a plurality of recipients. When the author indicates that the message is to be sent, a software package operating over a server associated with the author temporarily uploads from the author's system to the server a single copy of the file attached to the message. The software then transmits the message and a copy of the file corresponding to each attachment from the author's server to each of the designated recipients. Because only a single copy of a file corresponding to each attachment is maintained on the author's server, the memory and bandwidth allocations for the server are minimized.

In another aspect, the present invention relates to a method for distributing files over a server. In accordance with the method, an electronic message having a file attached thereto is provided which designates a plurality of recipients. A single copy of the file is uploaded to a first server. Then, for each designated recipient, the file is transmitted from the first server to the designated recipient.

In still another aspect, the present invention relates to a method for distributing files over a server. In accordance with the method, an electronic message having a file attached thereto is provided which designates a plurality of recipients. The attached file is resident on a first server, which may be associated with the author of the message. The message is then sent to each recipient along with an identifier that uniquely identifies the file. For each recipient, when the message is opened, the file is sent or downloaded from a second server to the recipient, the second server being distinct from the first server.

In another aspect, the present invention relates to a method for distributing media files over a computer network. In accordance with the method, an electronic message is received at a first server, the message including one or more recipients designated to receive a copy of the electronic message along with a specified file. The specified file may be a media file such as a multimedia file, and audio file, or a video file. The file is then identified, and a library of frequently transmitted files is searched to determine whether the specified file exists in the library. This library may be resident either on the first server or on a remote server. If the specified file exists in the library, a copy of the file is transmitted from a server specified in the library to the designated recipients. If the specified file does not exist in the library, a single copy of the file is uploaded to a predetermined server and transmitted to the designated recipients.

### BRIEF DESCRIPTION OF THE DRAWINGS

FIG. 1 is a flow chart illustrating a first embodiment of the methodology used to distribute files in accordance with present invention;

FIG. 2 is a flow chart illustrating a second embodiment of the methodology used to distribute files in accordance with present invention;

FIG. 3 is a flow chart illustrating a third embodiment of the methodology used to distribute files in accordance with present invention;

FIG. 4 is a schematic drawing illustrating a fourth embodiment of the methodology of the present invention; and

FIG. 5 is a schematic drawing of a system useful for implementing the methodology of the present invention.

### DETAILED DESCRIPTION OF THE INVENTION

The present invention relates to systems and methods for distributing large files, such as media files (e.g., audio, video, and multimedia files), over a server or other data exchange platform, and is especially well suited to the electronic distribution of music files over an electronic mail platform.

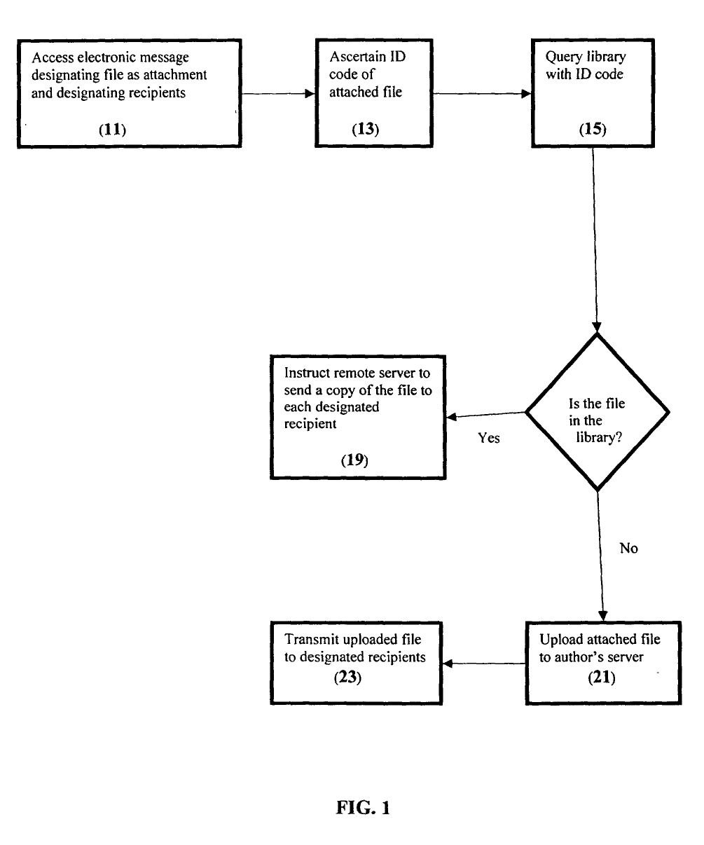

FIG. 1 illustrates a first embodiment of the methodology used to distribute files in accordance with the present invention. For ease of illustration, the discussion of this embodiment assumes that an electronic message attaching a single file is to be sent to a plurality of recipients, though one skilled in the art will appreciate that the methodology and system exemplified herein may also be applied to the distribution of electronic messages attaching multiple files, of the same or different types, and designating a single or multiple recipients.

In accordance with the embodiment depicted in FIG. 1, an electronic message is generated by an author which designates a file as an attachment and which designates a plurality of recipients. When the author indicates that the message is to be sent, a software package operating over the author's server accesses the message 11 and ascertains the identification of the attached file 13. The software is equipped with a library of frequently transmitted files which are present on one or more remote servers. This library may be static, or may be periodically modified or updated to reflect the addition or deletion of files from the one or more remote servers. The library may also be based, in part or in whole, on the author's previous choices of attachments, or on the choices of other users. Thus, for example, the library may be based on choices popular to the general public or to special interest groups (e.g., the 10,000 most popular songs of the decade). The software then queries the library to determine whether the attached file is in the library 17. If so, the software instructs the remote server to send a copy of the file directly to the e-mail address of each of the designated recipients 19. If not, the software sends the message and the attached file to the designated recipients in a conventional manner, that is, by uploading the file from the appropriate drive onto the author's server 21 and then transmitting the file and the associated electronic message to the designated recipients 23.

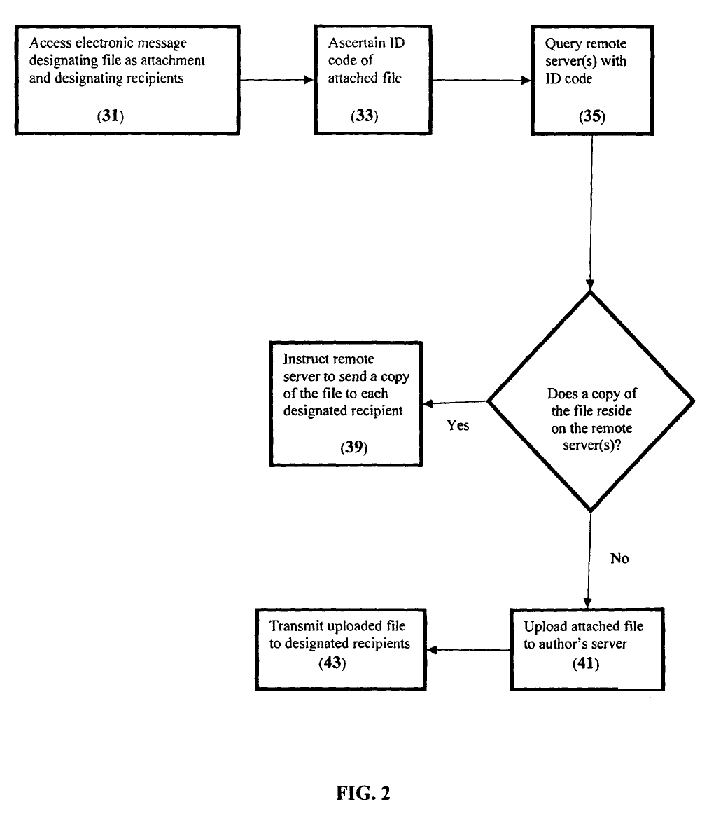

FIG. 2 depicts a second embodiment of the present invention which is similar in some respects to the embodiment depicted in FIG. 1. For ease of illustration, the same assumptions are made in describing this embodiment as were made in describing the embodiment of FIG. 1.

In accordance with the embodiment depicted in FIG. 2, an electronic message is generated by an author which designates a file as an attachment and which designates a plurality of recipients. When the author indicates that the message is to be sent, a software package operating over the author's server accesses the message 31 and ascertains the identification of the attached file 33. The software then queries one or more remote servers with the identification of the attached file 35 to determine if a copy of the file resides on one of the remote servers 37. If a duplicate of the file is found to reside on one of the remote servers, the remote server is instructed to send a copy of the file directly to the e-mail address of each of the designated recipients 39. These instructions may come from the software operating over the author's server, or they may come from software operating over the recipient's server or system. If a duplicate of the file is not found on one of the remote servers, the software sends the message and the attached file to the designated recipients in a conventional manner, that is, by uploading the file from the appropriate drive onto the author's server 41 and then transmitting the file and the associated electronic message to the designated recipients 43.

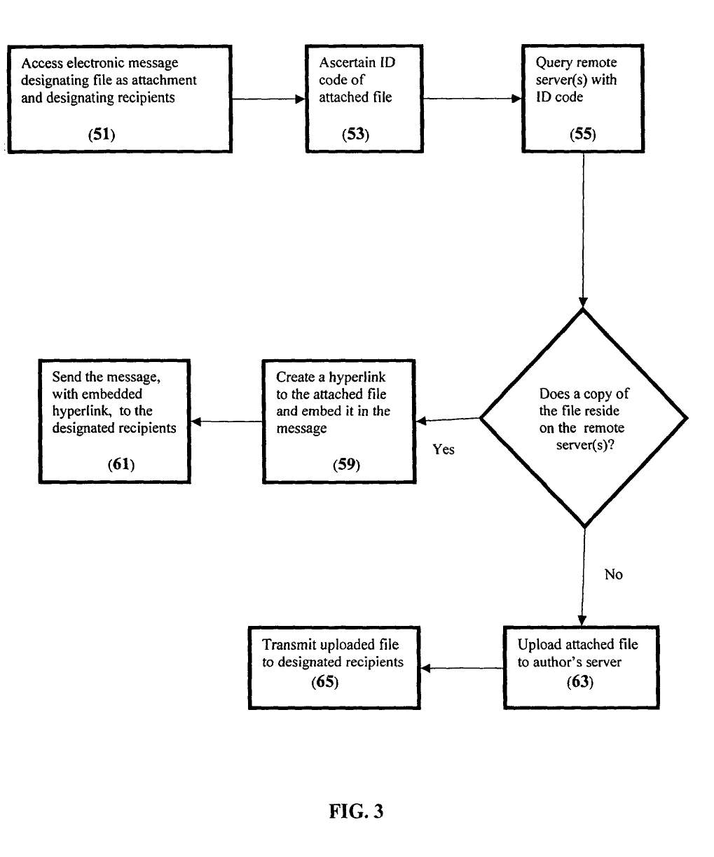

FIG. 3 depicts a third embodiment of the present invention which is similar in some respects to the first and second embodiments described above. In accordance with the embodiment depicted in FIG. 3, an electronic message is generated by an author which designates a file as an attachment and which designates a plurality of recipients. When the author indicates that the message is to be sent, a software package operating over the author's server accesses the message 51 and ascertains the identification of the attached file 53. The software then queries one or more remote servers with the identification of the attached file 55 to determine if a copy of the file resides on one of the remote servers 57. If a duplicate of the file is found to reside on one of the remote servers, the software then creates a hyperlink to the appropriate address on the remote server and incorporates the hyperlink into the message 59. The software then sends the message incorporating the hyperlink to the designated recipients 61. If no duplicate of the file is found on a remote server, the software sends the message and the attached file to the designated recipients in a conventional manner, that is, by uploading the file from the appropriate drive onto the author's server 63 and then transmitting the file and the associated electronic message to the designated recipients 65.

In the event that the file attached to the electronic message resides on more than one remote server that is queried by the software, various methods may be used to determine which address to incorporate into the hyperlink. In some embodiments, the address incorporated into the hyperlink will simply be that of the first server queried on which a copy of the attached file resides. In other embodiments, the address used in may be determined in accordance with various factors, which may or may not be user defined.

For example, if the file attached to the electronic message is a media file, multiple copies of the media file may exist on the same or different servers which differ only in file resolution or quality. Thus, for example, the same audio file may be encoded at different bit rates, with each bit rate giving rise to a separate file. In this case, the particular address selected for the hyperlink may be determined, for example, based on user preferences or predefined software settings. For example, the software may be adapted such that the user can specify that the hyperlink should always point to the highest resolution copy of the file available, in which case the software will query the remote servers to determine which server has the highest resolution copy of the file available, and will use the address of that server and file in the hyperlink. In the event that multiple servers contain copies of the file at the same maximum resolution, the particular server and copy of the file chosen to generate the hyperlink may be determined based on other factors, such as server speed and bandwidth limitations. In the event that the origins of the file are indicated or known, the software may also be adapted to generate a hyperlink which points to the origin of the file.

While hyperlinks can be used advantageously in this embodiment of the invention in that they are a widely accepted protocol for creating links within documents to remote files, the present invention is not limited to the use of hyperlinks, and it will be appreciated that other methods of forming a link between the electronic message and a remote file may also be used within the context of the present invention. Thus, for example, a link to the remote file may also be formed by embedding a pointer within the message or otherwise associating a pointer with the message. The pointer may contain sufficient information about the location and identity of the remote file such that the software system operating the electronic mail platform of a designated recipient can find and access the file over, for example, the Internet. This software may be adapted such that, when a designated recipient clicks on or otherwise opens a file attached to the electronic message, the software proceeds to automatically download the file from the remote site on which it resides into the recipient's server and/or drive.

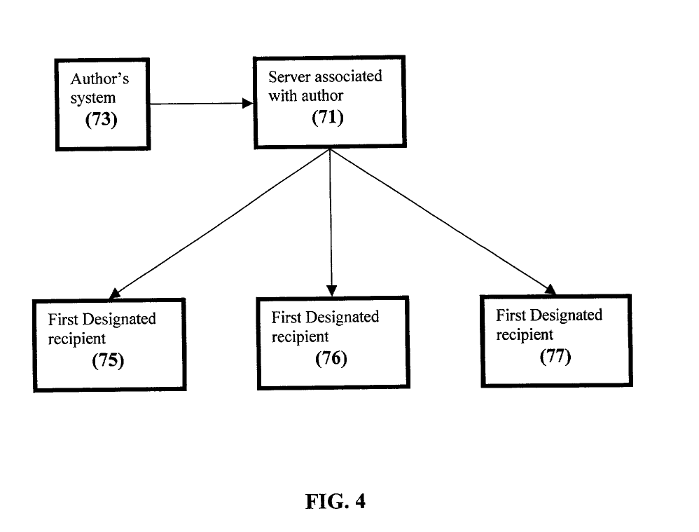

FIG. 4 illustrates a fourth embodiment of the methodology of the present invention. For ease of illustration, the discussion of this embodiment assumes that an electronic message attaching a single file is to be sent to a plurality of recipients, though one skilled in the art will appreciate that the methodology and system exemplified herein may also be applied to the distribution of electronic messages attaching multiple files, of the same or different types.

In accordance with this embodiment, an electronic message is generated by a user or author which designates a file as an attachment and which designates a plurality of recipients. When the author indicates that the message is to be sent (as by selecting “send” from a menu in the electronic mail system), a software package operating over a server 71 associated with the author temporarily uploads from the author's system 73 to the server a single copy of the file attached to the message. The software then transmits the message and a copy of the file corresponding to each attachment from the author's server to each of the designated recipients 75, 76, 77. The transmission may occur simultaneously to each of the designated recipients, or may occur sequentially in accordance with some predetermined protocol (e.g., in the order that the recipients are listed on the electronic message). Because only a single copy of a file corresponding to each attachment is maintained on the author's server, the memory and bandwidth allocations for the server are minimized.

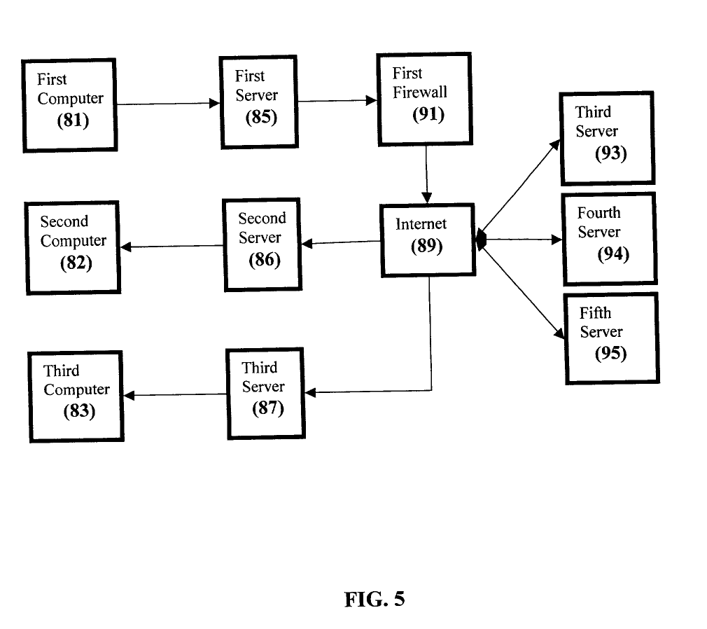

FIG. 5 illustrates an example of a system over which the methodologies of the present invention might be implemented. This system comprises first 81, second 82 and third computers 83 operated by first and second users, respectively. The first, second and third computers are connected to first 85, second 86 and third servers 87, respectively, and each of these servers has an electronic mail system operating over it. The first, second and third servers are interconnected via the Internet 89. In FIG. 5, only the first server is depicted as being connected to the Internet via a firewall 91; however, it will be appreciated by those skilled in the art that the second and third servers may likewise the connected to the Internet via a firewalls.

In the methodology of the embodiment of the present invention as described above, when an electronic message containing an attachment and designating a plurality of recipients (in this case, two) is generated on the first computer and is sent, a single copy of the file corresponding to the attachment is uploaded from the first computer to the first server. This copy and the associated message are then transmitted via the Internet to the second and third servers, where they are accessible in due course by the designated recipients via the second and third computer.

As shown in FIG. 5, the first server is also in communication via the Internet with fourth 93, fifth 94 and sixth servers 95. In the methodology of the first embodiment of the present invention as described above, when the electronic message is sent, a software system operating over the first server first inspects the message for the identification of the attachment, and then queries the fourth, fifth and sixth server to see if a copy of the attached file resides on any of these servers. If not, the file is uploaded from the first computer to the first server and is sent either in a conventional manner or in accordance with the methodology of the second embodiment of the present invention as described above. If so, the software incorporates a hyperlink or other such file address means into the electronic message and since this modified message, without a copy of the attached file, to the second and third servers via the Internet, where they are accessible in due course by the designated recipients via the second and third computer.

The various methodologies underlying the specific embodiments of the present invention may be used in conjunction with each other. For example, in the first embodiment, after the software has incorporated any appropriate hyperlinks into the message, the software may then load a single copy of the modified message onto the server corresponding to the author for transmission to the designated recipients. This conserves memory space and bandwidth in that only a single copy of the modified message is made to reside on the server. Moreover, in the event that it is not possible to create a hyperlink to a copy of the attached file residing on a remote server, only a single copy of this file will be uploaded to the server corresponding to the author.

The present invention may be utilized advantageously to distribute any type of file over a server to one or more recipients. However, the present invention is particularly advantageous for the distribution of large files to multiple recipients over a server, due to the efficiencies gained thereby. Thus, for example, the present invention is particularly useful for the distribution of media files, such as audio, video, and multimedia files, although it may also be applied to the distribution of other file types that are typically smaller, such as documents generated by word processors or spreadsheet software.

The present invention may be used for the distribution of media files having a wide variety of formats. Examples of such formats include, but are not limited to, MP3, MP3 CBR, MP3 VBR, RealAudio, Windows Media, MOD, 669, AMS, DBM, FAR, MDL, MTM, OKT, SM3, STM, ULT, XM, AIFF, AU, MID (or MIDI), VOC, WAV, and JPEG formats. Other file types include presentation files such as those generated by Microsoft® PowerPoint®, word processing file such as those generated by Microsoft Word® or WordPerfect®, and spreadsheet files such as those generated by Excel® spreadsheet software.

The software used to implement the methodologies of the present invention may take various forms. Thus, for example, the software may be present as a single program, or as an integrated package or suite of software components that are capable of operating together to achieve a common end. The software may also be disposed in various tangible media, including, but not limited to, hard drives, magnetic disks, and optical disks.

As noted above, some embodiments of the present invention may make use of an ID to uniquely identify a file in order to determine, for example, whether the file resides on a remote server, or to facilitate the retrieval of a file from a remote server. The IDs used for this purpose may be of various types, the important element being that they uniquely identified the file. Thus, for example, the ID may specify, or may have encoding corresponding to, the artist, the date the recording was made, the sampling rate at which the file was encoded, the title of the recording, the version of the recording, and/or other such data which will allow the file to be uniquely identified.

In those embodiments of the present invention which involve the downloading of an attached file from a remote server, various servers may be utilized for this purpose. In the event that more than one remote server is involved in this process, it is not necessary that each of the remote servers be configured in the same manner, so long as each of the remote servers is capable of complying with the instructions sent to it by the software operating over the author's server. Examples of server types which could be used for this purpose include, for example, directory servers such as Napster.

While the particular embodiments of the present invention illustrated above have been described with reference to electronic messages designating only a small number of recipients, it will be appreciated by those skilled in the art that the methodologies of the present invention are applicable to electronic messages having any number of recipients. Indeed, the efficiencies provided by the present invention will be most apparent, and will be most valuable, in instances where a large number of recipients are designated.

It will also be appreciated by those skilled in the art that the present invention is not limited to the distribution of files over an electronic mail the platform. Rather, the methodologies of the present invention and the efficiencies obtainable thereby can be readily adapted to virtually any file exchange platform or program operating over a server.

The foregoing description of specific embodiments of the present invention is merely illustrative and is not intended to be limiting. Accordingly, the scope of the present invention should be construed solely by reference to the appended claims.

What is claimed is:

1. A method for distributing media files over a computer network, comprising:
receiving at a server an electronic message that includes one or more recipients designated to receive said electronic message along with a specified media file;
identifying the specified media file;
searching a library of frequently transmitted media files to determine whether the specified media file exists in the library; and
if the specified media file exists in the library, transmitting a copy of the specified media file to said one or more recipients or, if the specified media file does not exist in the library, uploading the specified media file to a predetermined server and transmitting to said one or more recipients a copy of the specified media file from the predetermined server.

2. The method according to claim 1, wherein the specified media file comprises an audio file.

3. The method according to claim 1, wherein the specified media file comprises a video file.

4. The method according to claim 1, wherein the specified media file comprises a multimedia file.

5. The method according to claim 1, further comprising detecting a size of the specified media file attached to the electronic message.

6. The method according to claim 5, wherein the search of the library is performed only if the specified media file exceeds a predetermined size.

7. The method according to claim 1, further comprising logging a number of times a particular file is attached to an electronic message for transmission over the computer network.

8. The method according to claim 7, further comprising storing in said library a list of media files, each of which has been transmitted by electronic message over the computer network more than a predetermined number of times along with an associated location in the computer network for each file.

9. The method according to claim 7, further comprising ranking a plurality of media files based on how often each media file has been transmitted over the computer network.

10. The method according to claim 9, further comprising storing in said library an identity of a predetermined number of said ranked media files, which have been transmitted most often over the computer network electronically, along with a location in the computer network of each of said ranked media files.

11. A computer readable media having encoded thereon a plurality of instructions causing a processor to:
receiving at a server an electronic message that includes one or more recipients designated to receive said electronic message along with a specified media file;
identifying the specified media file;
searching a library of frequently transmitted media files to determine whether the specified media file exists in the library; and
if the specified media file exists in the library, transmitting a copy of the specified media file to said one or more recipients or, if the specified media file does not exist in the library, uploading the specified media file to a predetermined server and transmitting to said one or more recipients a copy of the specified media file from the predetermined server.

12. The computer readable media according to claim 11, wherein the specified media file comprises an audio file.

13. The computer readable media according to claim 11, wherein the specified media file comprises a video file.

14. The computer readable media according to claim 11, wherein the specified media file comprises a multimedia file.

15. A system for transferring media files from a sender to multiple recipients, comprising:
a server associated with a first computer; and
an electronic messaging system adapted to operate over the server, said messaging system being adapted to generate electronic messages of a first type which have at least one media file attached thereto and which designate a plurality of recipients, said messaging system being further adapted, when an electronic message of said first type is sent from said first computer, to
(a) identify the attached file,
(b) search a library of frequently transmitted files to determine whether the attached file exists in the library, and
(c) transmit, if the attached file exists in the library, a copy to said one or more recipients or, if the specified file does not exist in the library, upload the specified file to a predetermined server and transmit to said one or more recipients the specified file from the predetermined server.

16. The system of claim 15, wherein the file comprises a multimedia file.

17. The system of claim 15, wherein the file comprises an audio file.

18. The method of claim 15, wherein the file comprises a video file.

19. The system of claim 15, wherein the file is copied to a first recipient by copying the file from the first server to a second server associated with the first recipient.

20. The system of claim 15, wherein the message is generated on a system, and wherein the file is uploaded to the server from the system when the message is sent.

21. A method for distributing media files over a server, comprising:
providing an electronic message designating a plurality of recipients, said electronic message having a media file attached thereto, said media file being resident on said server;
sending the electronic message sans media file to each recipient along with an identifier that uniquely identifies the media file; and
forwarding, for each recipient when the message is opened by said each recipient, the file from said server to the recipient.

22. The method according to claim 21, further comprising removing the media file from the electronic message to be sent to the plurality of recipient before any uploading of the media file to the server can occur and prior to sending the electronic message sans media file to the plurality of recipients.

23. The method according to claim 21, further comprising inserting an identifier in the electronic message that uniquely identifies the media file and a location of the media file on a computer network.

24. The method according to claim 21, wherein the identifier comprises a hyperlink to a uniform resource locator (URL) on a computer network.
